(19) United States
(12) Patent Application Publication
(10) Pub. No.: US 2006/0161960 A1
(43) Pub. Date: Jul. 20, 2006

(54) Network security system appliance and systems based thereon

(76) Inventor: Brian V. Benoit, Edmonton (CA)

Correspondence Address: Gordon & Jacobson, P.C., 60 Long Ridge Road, Suite 407, Stamford, CT, 06902, US

(21) Appl. No.: 11/039,560

(22) Filed: Jan. 20, 2005

(51) Int. Cl. H04N 7/173; H04N 7/18

(52) U.S. Cl. 725/105; 348/159

(57) ABSTRACT

A network apparatus for use with a plurality of network cameras includes a system housing with a network interface (wireless access point and/or network switch), a router, and processing means that are operably coupled to one another and integrally housed within the system housing. The network interface provides communication links between the apparatus and the network cameras. The processing means preferaby performs automatic connection and configuration operations that upload default configuration settings to the network cameras through said communication links. Such automatic configuration operations are preferably carried out as part of DHCP address assignment. The processing means also preferably performs video proxy operations that buffer a plurality of video signals and that read out and multiplex together portions of the buffered video signals to form a composite signal for subsequent communication over the Internet. The apparatus may also include one or more of the following components integrally housed within the system housing: a hard disk for dvr recording, a battery backup power source, non-volatile storage (e.g., compact flash memory or hard disk) for storing digital video signals during a battery backup power mode, a plulality of ports that interface to alarm sensors and other alarm devices for alarm monitoring and automatic notification, and VPN processing. The processing means preferably includes an embedded web server for the configuration of the apparatus and possibly the network cameras. Kits and systems utilizing the network apparatus is also described and claimed.

### BACKGROUND OF THE INVENTION

1. Field of the Invention

This invention relates broadly to video delivery, recording and monitoring systems. More particularly, this invention relates to networked video delivery, recording and monitoring systems that utilize one or more cameras that interface to a Local Area Network (LAN) for the recording and viewing of video captured by such cameras, whereby such recording and viewing as well as administration of the networked system can be performed on a local node attached to the LAN or on a remote node attached to the Internet (or other Wide Area Network).

2. State of the Art

Traditional closed circuit TV (CCTV) systems employ multiple analog cameras that are connected to a multiplexer which in turn is connected to a video display and possibly a video recorder. Such systems are closed systems wherein the video signals are not communicated outside the local site where the system resides.

In the past several years, networked systems have emerged that utilize digital cameras and a digital video recorder (DVR) attached to a LAN. The digitized video signals generated by the cameras are encapsulated in data packets that are communicated over the LAN to the DVR. A separate web server machine, typically coupled to the LAN and the Internet by a router, provides a graphical interface that is accessible by a web browser executing on a computer system that is connected locally over the LAN or that is connected remotely over the Internet. This graphical interface provides user authentication as well as viewing of the live or recorded video streams from the DVR for authorized users. The graphical interface also provides for configuration and management of the DVR system and the network cameras. For example, such configuration and management typically provides for customization of video recording schedules, control over the generation of alarm notifications, and system usage tracking and logging.

The migration from closed security systems to networked security systems allow for great flexibility in the management, processing and usage of the now digitized video data. However, such flexibilities introduce many complexities with regard to the installation, set-up and maintenance of the diverse components required for such networked systems as compared to the simply managed closed systems. Such complexities make it impossible for a novice to install, administer, and maintain such networked systems. Thus, novice users are required to pay technical experts to install, administer, and maintain such networked systems, which limits the potential market for such networked systems.

### SUMMARY OF THE INVENTION

It is therefore an object of the invention to provide a networked security system (and components used therein) that can be installed, administered, and maintained by a novice.

It is another object of the invention to provide a networked security system that employs a modular unit with a broad range of features integrated therein to enable efficient configuration and administration of the system as well as lower cots; such features include network communication functionality, remote access to live and recorded video signals, alarm monitoring and possibly DVR recording.

It is a further object of the invention to provide such a system with remote access to a significant number of video signals over the bandwidth provided by standard broadband access systems (e.g., cable/dsl access systems).

It is also an object of the invention to use such remote access for offsite recording and viewing of the video signals.

In accord with these objects, which will be discussed in detail below, a network apparatus is provided that communicates with a plurality of network cameras. The network apparatus includes a system housing with a network interface (a wireless access point and/or a network switch), a router, and processing means that are operably coupled to one another and integrally housed within the system housing. The network interface provides for communication links between the apparatus and the plurality of network cameras. The processing means preferably includes an embedded web server for the configuration of the apparatus and possibly the network cameras.

According to one embodiment of the invention, the processing means performs automatic connection and configuration operations that upload default configuration settings to the plurality of network cameras through the communication links. Such automatic configuration operations are preferably carried out as part of DHCP address assignment. It will be appreciated that such automatic connection and configuration operations enable the networked security system (and components used therein) to be installed, administered, and maintained by a novice.

According to another embodiment of the invention, the processing means performs video proxy operations that buffers a plurality of video signals and that reads out and multiplexes together portions of the buffered video signals to form a composite signal for subsequent communication over the Internet/WAN. It will be appreciated that such video proxy operations enable remote access to a significant number of video signals over the bandwidth provided by standard broadband access systems (e.g., cable/dsl access systems). Such remote access can be used for offsite recording and viewing of such video signals.

According to yet another embodiment of the invention, the apparatus also includes one or more of the following components integrally housed within the system housing: a hard disk for dvr recording, a battery backup power source, non-volatile storage (e.g., a compact flash memory) for storing digital video signals during a battery backup power mode, a plurality of ports that interface to alarm sensors and other alarm devices for alarm monitoring and automatic notification, and VPN processing. It will be appreciated that such advanced features can be efficiently configured and maintained by the user and can be provided at lower costs.

Additional objects and advantages of the invention will become apparent to those skilled in the art upon reference to the detailed description taken in conjunction with the provided figures.

### BRIEF DESCRIPTION OF THE DRAWINGS

FIG. 1 is a block dagram of a networked security system with wireless IP cameras that communicate to a network security center appliance over a wireless local area network (WLAN) in accordance with the present invention; local system(s) communicate to the network security center appliance over a LAN or the WLAN; and remote systems communicate with the network security center appliance over the Internet.

FIG. 2 is a block diagram that illustrates the system architecture of an exemplary embodiment of the network security center appliance of FIG. 1;

FIGS. 3A and 3B, together, are a flow chart that illustrates exemplary automatic camera configuration operations carried out by the network security system appliance in accordance with the present invention.

### DETAILED DESCRIPTION

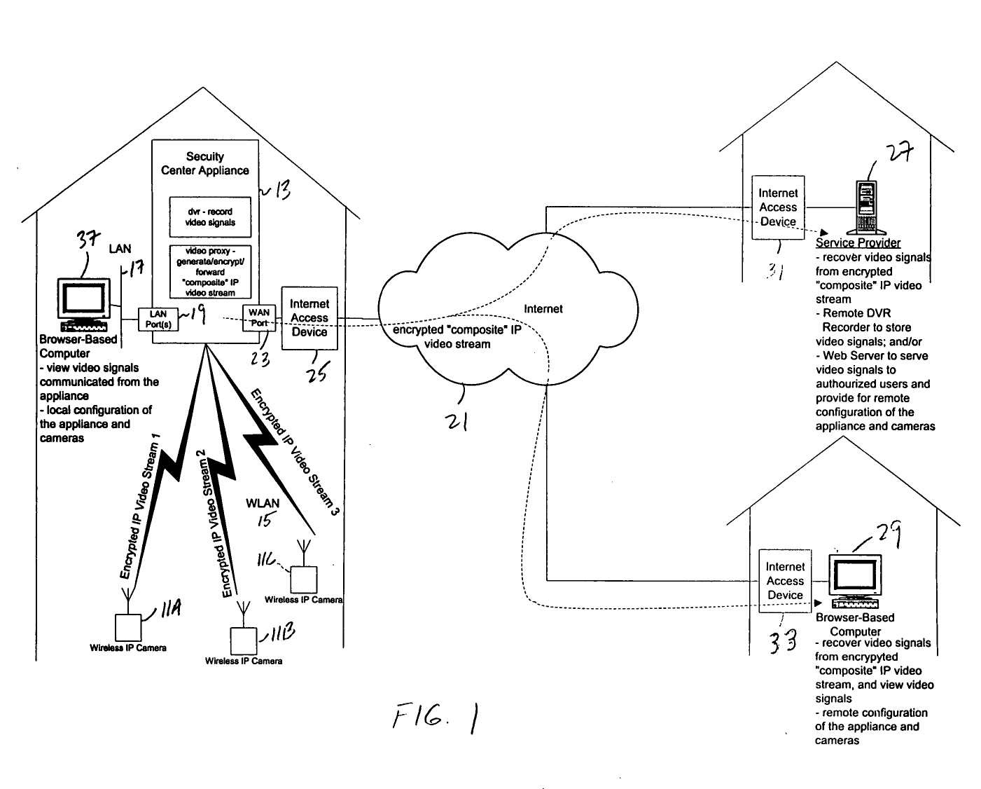

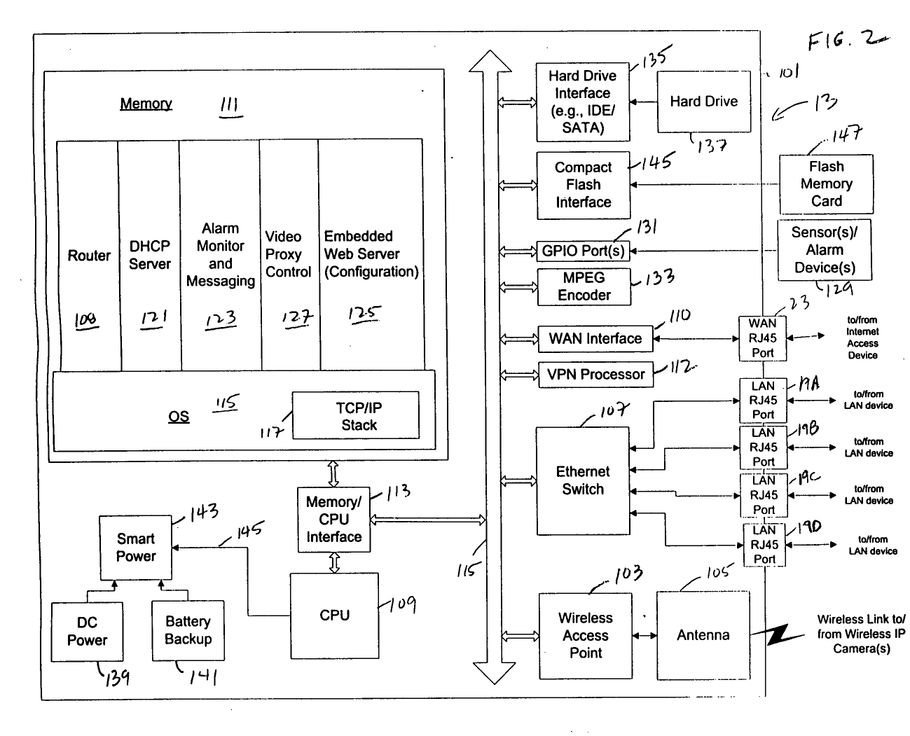

Turning now to FIG. 1, a networked security system in accordance with the present invention includes a number of wireless IP cameras (for example, three shown as 11A, 11B, 11C) that each transmits an encrypted IP video stream over a wireless LAN link. A network appliance 13 preferably includes the following components integrated into a system housing: i) a wireless access point 103 (FIG. 2) that provides bidirectional wireless communication between the wireless IP cameras and the appliance 13 over the Wireless LAN (WLAN) 15; ii) a network switch 107 (FIG. 2) that provides access to IP devices on the LAN 17 via LAN ports 19; iii) a router (software module 108 and WAN interface 110 of FIG. 2) that routes IP data packets between the Internet 21 and the WLAN 15/LAN 17 via the WAN port 23 and Internet Access Device 25 (e.g., an XDSL modem, Cable modem); the router preferably includes firewall features (e.g., network address translation), port forwarding features, and virtual private network (VPN) support (VPN coprocessor 110 of FIG. 2); iv) data storage means (e.g., memory 111 and hard disk 137 of FIG. 2) for the storage of digital data, including the buffering of digital video data as part of the video proxy functionality described below; and v) a system control processor 109 (FIG. 2) that controls the operation of the appliance, including the video proxy functionality described below.

As a video proxy, the appliance 13 receives an encrypted IP video stream transmitted by one or more of the wireless IP cameras 11A, 11B, 11C over the WLAN link therebetween and decrypts the received IP video stream(s). Each IP video stream is processed to recover a video signal encoded therein. Optionally, the recovered video signals are supplied to a video encoder 133 (FIG. 2) for compression into a lower bit rate video signal. The recovered video signals (or the compressed form output by the video encoder 133) are temporarily stored in buffers, which are realized by portions of the memory system 111 and possibly the hard disk 137. As the video signals are being written into the buffers, portions of these buffers are read out and multiplexed together to form a composite signal. The composite signal is encapsulated into an IP video stream—labelled “composite” IP video stream. The “composite” IP video stream is preferably encrypted by the VPN functionality of the router and communicated in encrypted form to a remote system (e.g., remote service provider system 27 or a browser-based computer system 29) over the Internet 21 (via the WAN port 23 and the Internet Access Device 25). The buffering of the video signals is necessary in order to accommodate communication of higher quality video signals (e.g., a frame rates greater than 20 fps) over the limited bandwidth provided by the Internet Access Device 25 for uplink communication from the appliance 13 to the remote system, which is typically between 300 Kbps and 2 Mbps for conventional cable and dsl access systems.

When communicated to a remote service provider system 27, the system 27 receives the “composite” IP video stream in encrypted form and decrypts it to recover the “composite” IP video stream, and the “composite” IP video stream is demultiplexed to recover the video signals therein. The system 27 may include digital video recorder functionality that records such video signals and possibly web server functionality that authenticates users (e.g., by user name and password) and serves the video signals recorded by the DVR functionality to authorized remote users that are operating browser-based computer systems connected thereto over the Internet 21 and the Internet Access Device 31. As described below, the remote browser-based computer system decodes (and possibly decompresses) such video signals for display on the computer system. In this manner, a remote user can monitor video signals that represent the video signals generated by the wireless IP cameras 11A, 11B, 11C from any browser-based computer system attached to the Internet. Monitoring at the service provider location can be accomplished in a similar manner by a browser-based computer that connects to the web server functionality of system 27 to access and display the recorded video signals served by the system 27. In the preferred embodiment, the communication of the “composite” IP video stream to the remote system can be selectively enabled to occur only at predetermined recording times according to a schedule dictated by the system administrator.

One or more of the video signals generated by the wireless IP cameras 11A, 11B, 11C and received by the appliance 13 (or possibly a compressed version of such video signals which can be produced by the video encoder 133) can also be communicated in real-time to the remote service provider system 27 or to a remote browser-based computer system 29. Such communication can employ the port forwarding features of the router functionality (e.g., software module 108 and WAN interface 110 of FIG. 2). In this case, the video signal generated by the a given wireless IP camera (or the compressed version) is forwarded by the router functionality over an assigned port for communication to the remote system. Alternatively, such communication can employ the VPN support (VPN coprocessor 112) of the router functionality for communication between the given wireless IP camera and the remote system. The remote service provider system 27 may include digital video recorder functionality that records the real-time video signals communicated from the appliance and/or web server functionality that authenticates users (e.g., by user name and password) and serves such real-time video signals (and/or possibly serves the stored video signals recorded by the DVR functionality) to authorized remote users that are operating browser-based computer systems connected thereto over the Internet 21 and the Internet Access Device 31. As described below, the remote browser-based computer system decodes (and possibly decompresses) such video signals for display on the computer system. In this manner, a remote user can monitor video signals that represent the video signals captured by the wireless IP cameras 11A, 11B, 11C from any browser-based computer system attached to the Internet. Monitoring at the service provider location can be accomplished in a similar manner by a browser-based computer that connects to the web server functionality of system 27 to access and display the recorded video signals served by the system 27. Similarly, such real time video signals can be communicated directly to a remote browser-based computer system for decoding and display. Such communication can employ the port forwarding features or the VPN support of the router functionality of the appliance for communication between the appliance 13 and the remote browser-based system. In this manner, a remote user can monitor video signals that represent the video signals captured by the wireless IP cameras 11A, 11B, 11C from any browser-based computer system attached to the Internet. In the preferred embodiment, the real-time communication of such video signals between the appliance and the remote system can be selectively enabled by the system administrator.

One or more of the video signals generated by the wireless IP cameras 11A, 11B, 11C and received by the appliance 13 (or possibly a compressed version of such video signals which can be produced by the video encoder 133) can also be communicated to a local system (e.g., a local browser-based computer 37) over the LAN 17 via a LAN port 19 (or possibly over the WLAN 15 via the wireless LAN interface integral thereto). In this case, the video proxy module 128 cooperates indirectly with the network switch 107 to communicate such video signal(s) to the local system over LAN 17 (or possibly with the wireless access point for communication over the WLAN 15). When communicated to the local browser-based computer system 37, the computer system 37 invokes a plug-in that decodes (and possibly decompresses) the video signal(s) to generate corresponding video signal(s) and renders the resultant video signal(s) for display on the computer. In this manner, a local user can monitor one or more video signals that represent the corresponding video signal(s) generated by the wireless IP cameras 11A, 11B, 11C from any browser-based computer system attached to the LAN 17. Such video signal(s) can be monitored in real-time in conjunction with the capture and generation by the wireless IP cameras 11A, 11B, 11C or some time later after they are recorded and saved by the DVR functionality of system 37.

The appliance 13 can optionally include DVR functionality (e.g., a hard disk 137 (FIG. 2) for non-volatile storage) that records the video signals generated by the wireless IP cameras 11A, 11B, 11C and received by the appliance 13 (or possibly a compressed version of such video signals which can be generated by the video encoder 133). Such DVR functionality can cooperate with web server functionality that serves the live or recorded video signals to local users and/or to remote users in a manner similar to the remote service provider system 27 as described above. In the preferred embodiment, the recording of the video signals by the appliance 13 can be selectively enabled to occur only at predetermined recording times according to a recording schedule dictated by the system administrator.

Each of the wireless IP cameras employ a video encoder that digitizes the analog video signal captured by the camera and preferably compresses the digital video signal so that it can be transmitted over the wireless network. The video encoder preferably produces an MPEG4 video signal, such as an MPEG4 short header video signal (which is an H.263 video stream encapsulated with MPEG-4 video stream headers). Each of the wireless IP cameras preferably employ a web-based configuration that allows for browser-based configuration operations of the respective camera. Such configuration operations provide for initialization and update of network configuration parameters (such as dynamic and/or static IP support for standard cable/dsl access systems, DNS settings, gateway address, DDNS settings, port forwarding settings, protocol settings between wireless camera and appliance such as UDP, TCP, HTTP, wireless communication settings such as service set identifier, mode, encryption enabled/disabled, encryption key), security settings (administrator name and password), audio settings, and video settings (control over resolution and bit rate of video signal stream generated by the camera, color setting). The wireless IP cameras 11A, 11B, 11C also preferably support features such as motorized pan/tilt control, a wired Ethernet interface/port, motion detection, one or more input ports that interface to an external alarm sensor, one or more output ports that interface to an external alarm device, and FTP/email transfer of still images triggered by motion detection or an external alarm sensor. For such cameras, the web-based configuration allows for browser-based operations that configure and control these features, such as preset configurations for the pan/tilt of the camera and the ability to move to such preset configurations, enablement or disablement of motion detection, schedule for predetermined time periods for transfer of still images, settings for event-driven transfer of still images, FTP settings used for FTP transfer of still images, and e-mail settings for email transfer of still images. For example, a wireless IP camera that supports such features is the PT3113 commercially available from Vivotek, Inc. of Taiwain.

FIG. 2 is a functional block diagram of an exemplary embodiment of the network appliance 13 having a system housing 101 with a number of subsystems integrated therein as shown. These subsystems include a wireless access point 103 that cooperates with an antenna 105 to provide bidirectional wireless communication between the wireless IP cameras and the appliance 13 over the WLAN 15. The wireless access point 103 is preferably compliant with industry standard wireless communication schemes such as IEEE 802.11a/b/and/or g. The wireless access point 103 can be realized in a single chip such as the BCM4318 single chip 802.11g transceiver commercially available from Broadcom Corporation of Irvine, Calif., which interfaces to the system control processor 109 preferably over a PCMCIA bus. This chip support a wide variety of standard wireless encryption schemes, such as 64/128 bit WEP, WPA-TKIP, and WPA-PSK. A network switch 107 (e.g., Ethernet switch) connects IP-enabled network devices on the LAN 17 via a plurality of RJ45 LAN ports (for example, 4 shown as 19A, 19B, 19C, 19D). The network switch 107 is preferably realized by a single chip solution such as the Atlantic™ VT6510/VT6510A Switch Controller commercially available from VIA Networking Technologies, Inc. of Taipei, Taiwan. In an alternate embodiment, the network switch 107 may be replaced by a single network interface (e.g., an ethernet controller such as the Rhine™ VT6105 Fast Ethernet Controller available from VIA Networking Technologies) that connects to an IP-enabled device via a single RJ45 port. In this configuration, the network interface can be used to provide local access to the device for configuration and management.

Router functionality (software module 108 and WAN interface 110) is provided that performs IP routing of data packets that are transmitted or received by the appliance 13 over the IP network links (LAN, Internet/WAN) of the system. The router functionality (module 108 and WAN interface 110) supports firewall features through network address translation as well as port forwarding features as is well known in the networking arts. The port forwarding features may be used to allow users to access the wireless IP cameras 11A, 11B, 11C via the Internet/WAN when the system administrator wishes them to be made accessible in this manner. The router functionality also performs VPN processing (e.g., packet processing, encryption/decryption tasks, etc) that are executed as part of a VPN endpoint. In this manner, the router functionality can support a VPN tunnel over Internet to another VPN endpoint as is well known in the networking arts. The router functionality is preferably realized by a software module 108 executing on the system control processor 109 operably coupled to the WAN interface 110 together with VPN support provided by a VPN coprocessor 112. The VPN coprocessor 112 may be realized by the IXP422 network processor that is commercially available from Intel Corporation of Santa Clara, Calif. The WAN network interface 110 is preferably provided by an ethernet controller. The WAN network interface 110 is coupled to an RJ45 WAN port 23 to provide Internet/WAN access via the Internet Access Device 25 of the system.

A system control processor 109 and system memory 111 (such as Synchronous or DDR DRAM memory) are interfaced to one another by interface circuitry 113. The interface circuitry 113 also provides an interface to various other components of the appliance over a communication bus 115. The communication bus 115 is shown as a single entity for simplicity of description, but it may be realized by a hierarchical bus structure, multiple bus structures or any other data bus scheme. An exemplary embodiment of the system control processor 109, system memory 111, interface circuitry 113 and the communication bus 115 is realized by the EPIA PD-Series Mini-ITX mainboard commercially avaialbe from VIA Technologies of Taipai, Taiwain. This mainboard employs the VIA Eden™ processor, the VIA CLE266 North Bridge, VIA VT8235 South Bridge, a single DDR266 DIMM socket for system memory up to 1 GB in size, a VIA UniChrome™ AGP graphics adapter, a single PCI expansion slot, two Ethernet controllers (VIA VT6105 and VT6103), various I/O capabilities, an ATX Power Connector, FAN connectors, an IDE controller with two PCI UltraDMA connectors, as well as other features.

The system memory 111 stores an operating system 115 that is executed on the system control processor 109 to control the real-time operation of the appliance 13. The operating system 115, such as a Linux-based operating system suitable for operation in conjunction with the VIA mainboard described above, includes a TCPIP stack 117 that supports TCPIP protocol processing for data packets that are transmitted or received by the appliance 13 over the IP network links (LAN, Internet/WAN) of the system. The operating system 115, including the TCPIP stack 117, supports the execution of a number of software modules 121, 123, 125, 127 on the processor 109, each of which is discussed below in detail.

Software module 121 comprises a DHCP server that is adapted to dynamically assign IP addresses to IP devices that are attached to the LAN 17 and WLAN 15 of the system upon connection of such devices to the LAN and WLAN of the system, which typically occurs at power-up of such devices.

Software module 123 monitors the signals generated by one or more external sensors 129. The external sensor(s) 129, which may be any one of many different types such as a contact sensor, heat/smoke sensor, window break sensor, door sensor, etc., are preferably coupled to the CPU 109 via one or more GPIO ports 131 as shown. A change in the signal level at the given GPIO port raises an interrupt at the CPU 109. This interrupt triggers the alarm monitoring module 123 to carry out automatic notification operations. Such automatic notification operations may involve activating an alarm (e.g., siren) coupled thereto by the GPIO port(s) 131 and/or electronic notification. The electronic notification may involve e-mailing, paging, text messaging, instant messaging, or other messaging mechanisms, which are typically carried out over the Internet. Such messaging can be directed to multiple recipients in parallel (such as to the user's e-mail account and to a security service provider's email account). In the preferred embodiment, the appliance 13 supports up to ten alarm sensors/devices.

Software module 125 comprises an embedded web server that is adapted to serve web pages that provide a graphical user interface for the initialization and update of various configuration parameters of the appliance 13 itself, such as the network settings for the router 108 and the wireless access point 103, security settings for administration of the appliance 13, settings for the alarm monitoring and notification module 123 (e.g., email settings, instant messaging settings, pager numbers, cell phone numbers for text messages, etc.) and settings for the video proxy control module 127 as described below. For example, the graphical user interface can allow the system administrator to define the time periods that the dvr functionality of the appliance 13 is enabled. This feature allows the system administrator to program the appliance 13 such that the received video signals are recorded only during such time periods. Similarly, the graphical user interface can allow the system administrator to set the time periods during which the generation and/or communication of the “composite” IP video signal to the remote system is enabled. This feature allows the system administrator to limit the time periods that the composite video signal is accessible over the Internet/WAN.

The web pages served by the embedded web server module 127 also provide a graphical user interface for the initialization and update of the configuration parameters of the wireless IP cameras of the system. Such configuration parameters include network configuration parameters (such as dynamic and static IP support for standard cable/dsl access systems, DNS settings, gateway address, DDNS, port forwarding settings, protocol settings between wireless camera and appliance such as UDP, TCP, HTTP, wireless communication settings such as service set identifier, mode, encryption enabled/disabled, encryption key), security settings (administrator name and password), audio settings, video settings (control over resolution and bit rate of video signal stream generated by the camera, color settings, recording schedule for still image forwarding, settings for event-driven still image forwarding triggered by motion detection or an external alarm sensor), motorized pan/tilt control, motion detection control, external alarm sensor/device control, and FTP/email settings for transfer of still images. The graphical user interface can provide for initialization and update of such configuration parameters (or a subset of these configuration parameters) on a group basis—the configuration parameters are applied to the set of IP wireless cameras of the system (or to a group of such wireless IP cameras). In addition, the graphical user interface can provide for initialization and update of such configuration parameters (or a subset of these configuration parameters) on a per-camera basis—the configuration parameters are applied to an individual IP wireless camera. Such per-camera configuration can be realized by configuring the web server module 127 as a web proxy for the embedded web server of the individual IP wireless cameras.

Software module 127 performs control over the video proxy operations carried out by the appliance 13. Software module 127 optionally cooperates with a hardware video encoder 133 that operates on a video signal supplied thereto to compress it into a lower bit rate signal. In the preferred embodiment, the video encoder 133 outputs an MPEG4 part 10 video signal (also referred to as an H.264 video signal). In this embodiment, the video encoder 133 performs video compression tasks such as AC/DC prediction and motion estimation, motion compensation and vector generation in order to significantly decrease the bandwidth demands for communicating the supplied video signal over the Internet. The hardware video encoder 133 is preferably realized by a single chip solution such as the TMS320C64x family of digital media processors, commercially available from Texas Instruments Incorporated of Dallas, Tex. programmed with H.264 decoder functionality commercially available from Ateme of Paris, France.

As part of the a video proxy operations carried out by the appliance 13, the wireless access point 103 receives encrypted IP video streams transmitted by the wireless IP cameras over the WLAN link therebetween and decrypts the received IP video streams to recover the video signal within each received IP video stream. The video proxy control module 127 optionally cooperates with the video encoder 133 to supply it with such video signals (e.g., MPEG4 short form header video signals), where each video signal is compressed into a lower bit rate video signal (e.g., an MPEG4 part 10/H.264 video signal). In alternate embodiments, the video encoder 133 may be adapted to perform a suitable video transcoding operation that transforms the received video signals into the desired output format. The video proxy control module 127 temporarily stores the recovered video signals (or compressed versions generated by the video encoder 133) in buffers, which are realized by portions of the memory system 111 and possibly the hard disk 137. As the video signals are being written into the buffers, portions of these buffers are read out and multiplexed together to form a composite signal In the preferred embodiment, the functionality of appliance 13 supports up to 16 cameras. In this configuration, the video proxy control module 127 and the video encoder 122 support the buffering and multiplexing of up to 16 video signals into the composite signal. The composite signal is encapsulated into an IP video stream—labelled “composite” IP video stream. The “composite” IP video stream is preferably encrypted by the VPN functionality of the router and communicated in encrypted form to a remote system (e.g., remote service provider system 27 or a browser-based computer system 29) over the Internet 21 (via the WAN port 23 and the Internet Access Device 25). The buffering of the video signals is necessary in order to accommodate communication of up to sixteen higher quality video signals (e.g., a frame rates greater than 20 fps) over the limited bandwidth provided by the Internet.Access Device 25 for uplink communication from the appliance 13 to the remote system, which is typically between 300 Kbps and 2 Mbps for conventional cable and dsl access systems. In such configurations, the remote system recovers the composite signal, demultiplexes the composite signal to recover the video signals therein, and decodes and decompresses these video signals for recording or viewing. When the video signals are MPEG4 part 10/H.264 video signals, such decoding and decompression operations require a suitable MPEG4 decoder. Such functionality is readily available in software (e.g., an MPEG4 decoder plug-in for a browser-based computer, such as the DIVX plug-in which is available from DivXNetworks, Inc. of San Diego, Calif.) and in hardware (e.g, the EM8400 which is commercially available from Sigma Designs, Inc. of Milpitas, Calif.). In the preferred embodiment, the generation and/or communication of the “composite” IP video signal from the appliance 13 to the remote system is selectively enabled to occur only at predetermined times according to a schedule dictated by the system administrator via interaction with the graphical user interface presented by the web server 125. This feature allows the system administrator to limit the time periods that the composite video signal is accessible over the Internet/WAN.

The video signals generated by the wireless IP cameras 11A, 11B, 11C and received by the appliance 13 (or possibly compressed version of such signals as generated by the video encoder 133) can also be communicated to a local system (e.g., a local browser-based computer 37) over the LAN 17 via a LAN port 19 (or possibly over the WLAN 15 via the wireless LAN interface integral thereto). In this mode, the video proxy control module 127 cooperates indirectly with the network switch 107 (or the wireless access point 107) to forward the received video signal (e.g. the MPEG4 short header video signal), or a compressed version of such video signal, to the local system. The local system invokes a video decoder (e.g., a plug-in video decoder) that decodes and possibly decompresses the video signals for display. In this manner, a local user can monitor video signals that represent the video signals generated by the wireless IP cameras 11A, 11B, 11C from any browser-based computer system attached to the LAN 17 (or WLAN 15). Such video signals can be monitored in real-time in conjunction with their capture and generation by the wireless IP cameras 11A, 11B, 11C or some time later after they are recorded and saved by the DVR functionality of system 37.

The appliance 13 optionally includes a hard drive interface controller 135 and a hard disk 137 to provide non-volatile storage for DVR functionality. The video proxy control module 127 cooperates with the hard disk 137 to record the video signals generated by the wireless IP cameras 11A, 11B, 11C and received by the appliance 13 (or possibly a compressed version of such video signals). Alternatively, the hard disk 137 can be external to the appliance 13 and operably coupled thereto over a wired data interface (such as USB or IEEE 1394 link), or possibly over a network link when realized as a network attached storage device (e.g., a hard drive storage operably coupled over the LAN 19). In the preferred embodiment, the recording of the video signals by the hard disk 137 is selectively enabled to occur only at predetermined recording times according to a recording schedule dictated by the system administrator via interaction with the graphical user interface presented by the web server 125. This feature allows the system administrator to program the appliance 13 such that the received video signals are recorded only during such time periods.

The embedded web server 125 may also be adapted to serve the live video signals received by the appliance 13 (or the video signals recorded by the DVR functionality of the appliance 13) to local users and/or to remote users in a manner similar to the remote service provider system 27 as described above.

The appliance 13 preferably provides for automatic connection and configuration of the wireless IP cameras of the system. In the preferred embodiment, a set of wireless IP cameras (preferably 16 in number) are packaged together for distrubution to a customer. Each one of the wireless IP cameras of the set is assigned a camera identifier. Before the cameras are packaged with the appliance 13, the camera identifiers are loaded into their corresponding cameras and stored persistently therein (e.g., in a predetermined location in flash memory). The camera identifiers for the set are also loaded into the appliance 13 and stored in persistently therein (e.g., in a file on the hard disk 137 or possibly in a predetermined location in flash memory). In addition, a default service set identifier (SSID) is persistently stored in each one of the cameras of the set as well as in the appliance 13. During the initial power on of each respective wireless IP camera in set, the default SSID persistently stored by both the respective wireless IP camera and the appliance 13 is used to establish the wireless connection therebetween. Because the default SSID is known by the wireless cameras as well as the appliance 13 “out of the box,” the default configuration of the appliance 13 can be set such the broadcast of the SSID is disabled, which improves the security of the system.

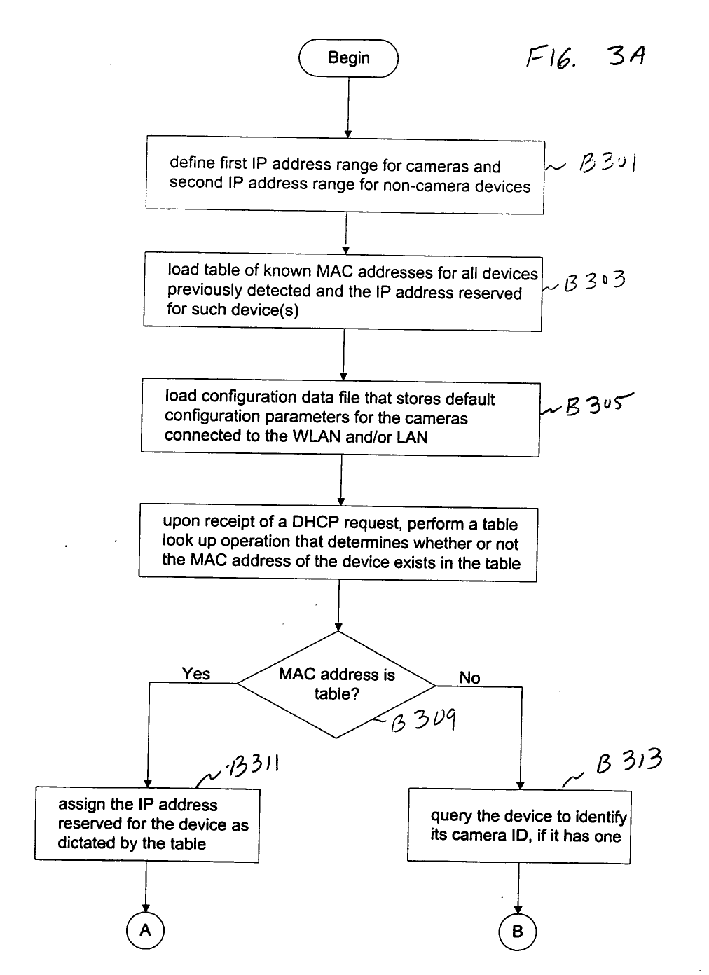

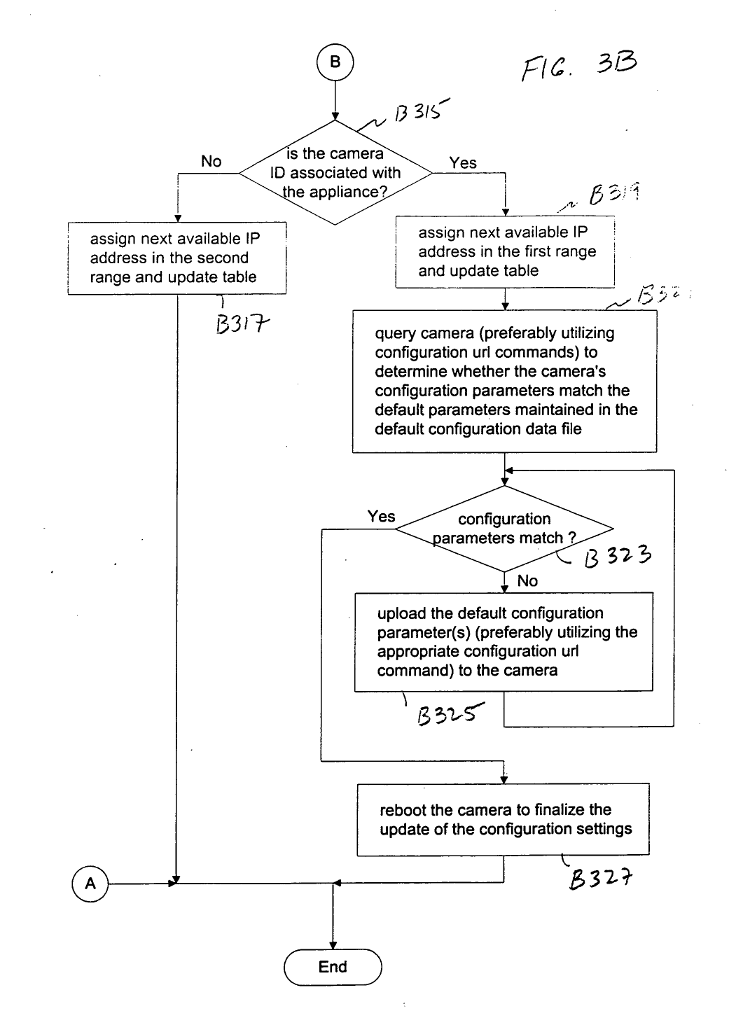

After a wireless connection is established for a respective wireless IP camera, the respective wireless IP camera cooperates with the DHCP server module 121 executing on the system control processor 109 to carry out dynamic IP address assignment. More particularly, the DHCP server module 121 dynamically assigns an IP address to a device (including the wireless IP cameras of the system) upon initial connection of the device to the LAN 17 and/or WLAN 15, which typically occurs at power-up of the device. The operations of the DHCP server module 121 are illustrated in the flow chart of FIGS. 3(A), and (B), collectively. In block B301, a first range of IP addresses is defined for cameras, while a second range of IP addresses (that does not overlap with the first range) is defined for non-camera devices. The feature allows for the IP filtering functionality of the router 108 to effectively prevent unauthorized network access to the cameras of the system. The DHCP server module 121 also maintains a table of known MAC addresses for all devices previously detected by the DHCP server module 121 and the IP address reserved for such device(s). This table is loaded into the system memory 111 in block B303. The DHCP server module 121 also maintains a configuration data file that stores default configuration parameters for the cameras connected to the WLAN 15 (and/or LAN 17). This configuration data file is loaded into the system memory 111 in block B305. When a device issues a DHCP request (typically upon initial connection to the LAN 17 or WLAN 15), the DHCP server module 121 performs a table look up operation that determines whether or not the MAC address of the device exists in the table (block B307). If the MAC address is known (yes path of block B309), the device is assigned the IP address reserved for the device as dictated by the table (block B311) and the operations end. If the MAC address is not known (no path of block B309), the DHCP server 121 queries the device to identify the camera identifier persistently stored by the device, if it has one (block B313). In block B315, it is determined whether the camera identifier identified in block B313 is associated with the appliance (e.g., is it within the set of camera identifiers persistently stored by the appliance?). If not (no path of block B315), the DHCP server 121 assigns the next available IP address in the range designed for non-camera devices to the device and adds a new entry to the table for the device (block B317) and the operations end. If so (yes path of block B315), the DHCP server 121 assigns the next available IP address in the range designated for cameras to the camera, and adds a new entry to the table for the camera (block B319). It also queries the camera (preferably utilizing one or more configuration URL commands as are well known) to determine whether the camera's configuration parameters (or subset thereof) matches the default parameters maintained in the default configuration file (block B321). If a given configuration parameter does not match (no path of block B323), the DHCP server module 121 automatically uploads the default configuration parameter (preferably utilizing the appropriate configuration URL command) to the camera (block B325). The update operation of block B323 is repeated until all of the desired configuration parameters of the camera are updated and match the default setting (yes path of block B323), and then the DHCP server module 121 automatically reboots the camera to finalize the update of such configuration settings in accordance with the default configuration file (block B327) and the operations end. Such automatic configuration operations minimize the know-how required by the user to set-up and initialize the features of the cameras, including for example:
network configuration parameters (such as dynamic and static IP support for standard cable/dsl access systems, DNS settings, gateway address, DDNS settings, port forwarding settings, protocol settings between wireless camera and appliance such as UDP, TCP, HTTP, wireless communication settings such as service set identifier, mode, encryption enabled/disabled, encryption key);
security settings (administrator name and password);
audio settings;
video settings (control over resolution and bit rate of video signal stream generated by the camera, color settings);
motion detection, settings for the external alarm sensor/device ports;
time periods for still image transfer;
control over event-driven still image transfer triggered by motion detection or an external alarm sensor; and/or
FTP/email settings for still image transfer.
   Such operations can be used to automatically configure any other operational parameters of the camera as desired.

Returning to FIG. 2, the appliance 13 preferably includes a DC power supply 139 and a battery power source 141. The DC power supply 139 may be realized by an external (or internal) AC/DC power converter that converts AC mains power to a DC voltage level and power regulation circuitry that derives the desired output DC power signals from the DC signal output from the AC/DC converter. The DC power source 139 and the battery power source 141 are coupled to smart power circuitry 143 that selectively couples either the DC power source 139 or the battery power source 141 to components of the system. During normal operation, the smart power circuitry 143 couples the DC power source to these components. The system control processor 109 monitors the status of the Internet/WAN network connection. If the Internet/WAN network connection is diconnected (which typically occurs during a power outage), the system control processor 109 signals the smart power circuitry 143 over control path 145. In response thereto, the smart power circuitry 143 couples the battery power source 141 to the system components. In this “Internet/WAN disconnected” state, the battery power source 141 provides the necessary voltage levels to power at least the system control processor 109, the memory system 111, the interface 113, the wireless access point 103, and a compact flash interface 145. The compact flash interface 145 provides access to non-volatile flash-type memory. Preferably, the flash-type memory is embodied in a memory card 147 that is inserted through a slot in the system housing such that it is connected to the interface 145. Alternatively, such flash-type memory can be integrally housed within the system housing. Upon determination that the Internet/WAN connection is disconnected, the system control processor 109 also cooperates with the compact flash interface 145 to record on the flash-type memory operably coupled thereto (e.g., card 147) the video signals communicated from the wireless IP camera and received by the wireless access point 103 for a limited period of time (which is preferably twenty minutes or more). The interface 145 and flash-type memory can also be used to store configuration data for the appliance 13 such that this configuration data can be automatically restored when the AC power is restored. Alternatively, the hard drive 137 can be powered on in the “Internet/WAN disconnect” state and used to record the digital video signals in this mode. Similarly, an external hard disk or network storage can be used to record digital video signals in this mode. In yet another alternative embodiment, an UPS device can be used to provide battery backup power to the apparatus in the case of a power failure.

The security center appliance as described above interfaces to a number of wireless IP cameras. It can be readily adapted to interface to wired IP cameras (via the LAN), traditional analog cameras (via an IP video server interface and the LAN), or other cameras. The IP video server interface to the analog cameras may be integrated into the security center appliance itself. In such configurations, the video signals received by the appliance may be compressed (or transcoded) by the video encoder 133 prior to subsequent digital recording or communication over the Internet/WAN or LAN of the system as described herein for the video signals generated by the wireless IP cameras and received by the appliance 13.

In accordance with the present invention, the security center appliance described herein may be bundled with one or more wireless IP cameras (and/or possibly one or more wired IP cameras) and distributed as a kit. The automatic connection and configuration operations of the security center appliance as described herein allow a novice user/administrator to install, administer and maintain the networked security systems described herein while eliminating the complexities normally associated with such networked systems.

There have been described and illustrated herein embodiments of a networked security system appliance and a security system based thereon. While particular embodiments of the invention have been described, it is not intended that the invention be limited thereto, as it is intended that the invention be as broad in scope as the art will allow and that the specification be read likewise. Thus, while particular video format signals have been disclosed, it will be appreciated that other video format signals can be used as well. In addition, while particular types of communication protocols and interfaces have been disclosed, it will be understood that other protcols and interfaces can be used. Moreover, while particular configurations have been disclosed in reference to the system architecture of the system appliance, it will be appreciated that other configurations could be used as well. It will therefore be appreciated by those skilled in the art that yet other modifications could be made to the provided invention without deviating from its spirit and scope as claimed.

What is claimed is:

1. An apparatus for use with a plurality of network cameras, the apparatus comprising:
a system housing; and
a network interface, a router, and processing means that are operably coupled to one another and integrally housed within said system housing, wherein
said network interface provides communication links between said apparatus and said plurality of network cameras, and
said processing means performs automatic configuration operations that upload default configuration settings to said plurality of network cameras through said communication links.

2. An apparatus according to claim 1, wherein:
said plurality of network cameras comprise wireless IP cameras, and said network interface comprises a wireless access point.

3. An apparatus according to claim 1, wherein:
said plurality of network cameras comprise wired IP cameras, and said network interface comprises a network switch.

4. An apparatus according to claim 1, wherein:
said network interface comprises a wireless access point and a network switch.

5. An apparatus according to claim 2, wherein:
said wireless access point includes means for broadcasting a service set indentifier, which is disabled in a default configuration; and
said apparatus further includes storage means for persistently storing a default service set identifier that matches that persistently stored by said wireless IP cameras, wherein said default service set identifier is used to establish a wireless connection between each respective wireless IP camera and said apparatus.

6. An apparatus according to claim 1, wherein:
said automatic configuration operations are carried out by the processing means as part of software module that performs DHCP address assignment.

7. An apparatus according to claim 6, further comprising:
storage means for persistently storing camera identifiers assigned to a set of network cameras associated therewith, said camera identifiers matching those persistently stored by said set of network cameras.

8. An apparatus according to claim 7, wherein
said software module
i) maintains a table of MAC addresses for previously detected devices and a reserved IP address for each previously detected device,
ii) in response to a request issued by a connected device having a MAC address associated therewith, queries said table to determine whether or not the MAC address of said connected device exists within said table;
iii) in the event that the MAC address of said connected device is not within said table, queries said connected device to determine if said connected device persistently stores a camera identifier that matches those persistently stored by said apparatus; and
iv) in the event that said connected device persistently stores a camera identifier that matches those persistently stored by said apparatus, assigns an available IP address to the connected device, and updates said table with the MAC address and IP address for said connected device.

9. An apparatus according to claim 8, wherein:
said automatic configuration operations are performed subsequent to the IP address assignment and table update operations of iv).

10. An apparatus according to claim 1, wherein:
said default configuration settings are uploaded to said plurality of network cameras using configuration URL commands communicated over said communication links.

11. A kit comprising:
the apparatus of claim 2; and
a plurality of wireless IP cameras that communicate to the wireless access point of said apparatus.

12. A kit comprising:
the apparatus of claim 3, and
a plurality of wired IP cameras that communicate to the network switch of said apparatus.

13. A kit comprising:
the apparatus of claim 4;
a plurality of wireless IP cameras that communicate to the wireless access point of said apparatus; and
a plurality of wired IP cameras that communicate to the network switch of said apparatus.

14. An apparatus for use with a plurality of network cameras, the apparatus comprising:
a system housing having a network interface, a router and processing means that are operably coupled to one another and integrally housed within said system housing, wherein said network interface provides communication links between said apparatus and said plurality of network cameras; and
non-voltatile memory that cooperates with said processing means to automatically store digital video signals received by said apparatus in a predetermined state.

15. An apparatus according to claim 14, wherein:
said predetermined state corresponds to the connection state of the apparatus to the Internet/WAN.

16. An apparatus according to claim 14, wherein:
a battery backup power source powers components of said apparatus in said predetermined state.

17. An apparatus according to claim 16, wherein:
said battery backup power source is integrally housed within said system housing.

18. An apparatus according to claim 16, wherein:
said non-volatile memory is integral to said apparatus.

19. An apparatus according to claim 14, wherein:
said plurality of network cameras comprise wireless IP cameras, and said network interface comprises a wireless access point.

20. An apparatus according to claim 14, wherein:
said plurality of network cameras comprise wired IP cameras, and said network interface comprises a network switch.

21. An apparatus according to claim 14, wherein:
said network interface comprises a wireless access point and a network switch.

22. An apparatus according to claim 14, wherein:
said non-volatile memory comprises a memory card.

23. An apparatus according to claim 14, wherein:
said non-volatile memory comprises a hard disk integrally housed within the system housing.

24. An apparatus according to claim 23, wherein:
said hard disk cooperates with the processing means to record digital video signals derived from video signals received by said apparatus,

25. An apparatus according to claim 14, further comprising:
a plurality of ports, integrally housed within the system housing, that interface to alarm sensors and other alarm devices, wherein said processing means monitors status signals at said ports to trigger automomatic nofification operation based upon the status signals of said ports.

26. An apparatus according to claim 14, further comprising:
VPN processing means, integrated with said router, to provide at least one packet-based VPN tunnel connection over the Internet.

27. An apparatus according to claim 14, wherein:
said processing means includes a software module that carries out web serving functionality for the configuration and administration of the apparatus.

28. A kit comprising:
the apparatus of claim 19; and
a plurality of wireless IP cameras that communicate to the wireless access point of said apparatus.

29. A kit comprising:
the apparatus of claim 20, and
a plurality of wired IP cameras that communicate to the network switch of said apparatus.

30. A kit comprising:
the apparatus of claim 21;
a plurality of wireless IP cameras that communicate to the wireless access point of said apparatus; and
a plurality of wired IP cameras that communicate to the network switch of said apparatus.

31. An apparatus for use with a plurality of network cameras, the apparatus comprising:
a system housing; and
a network interface, a router, and processing means that are operably coupled to one another and integrally housed within said system housing, wherein
said network interface provides for communication links between said apparatus and said plurality of network cameras, and
said processing means performs video proxy operations that buffer a plurality of video signals derived from real-time video signals received by said apparatus, and that read out and multiplex together portions of the buffered video signals to form a composite signal for communication from the appliance.

32. An apparatus according to claim 31, wherein:
said plurality of network cameras comprise wireless IP cameras, and said network interface comprises a wireless access point.

33. An apparatus according to claim 31, wherein:
said plurality of network cameras comprise wired IP cameras, and said network interface comprises a network switch.

34. An apparatus according to claim 31, wherein:
said network interface comprises a wireless access point and a network switch.

35. An apparatus according to claim 31, wherein:
said buffered video signals are compressed versions of said real-time video signals.

36. An apparatus according to claim 35, wherein:
said processing means comprises a hardware-based encoder that performs video compression alogirthms on said real-time video signals to produce compression versions of said real-time video signals.

37. An apparatus according to claim 31, wherein:
said processing means encapsulates said composite video signal into IP packets for communication over an Internet/WAN network link connected to the apparatus.

38. An apparatus according to claim 31, wherein:
said composite signal is communication over a broadband communication link having a bandwidth between 300 Kbps and 2 MBps.

39. An apparatus according to claim 31, wherein:
said composite signal is derived by multiplexing together sixteen video signals derived from sixteen real-time video signals received by said apparatus.

40. An apparatus according to claim 31, wherein:
said processing means includes a software module that carries out web serving functionality for the configuration of the video proxy operations carried out by the apparatus.

41. An apparatus according to claim 40, further comprising:
a hard disk, integrally housed within said system housing, that cooperates with said said processing means to record digital video signals derived from video signals received by said apparatus.

42. An apparatus according to claim 41, wherein:
the web server functionality of said software module communicates digital video signals recorded by the hard disk over a network link connected to the apparatus, said network link comprising one of a LAN network link, a WLAN network link, and an Internet/WAN network llink.

43. An apparatus according to claim 41, wherein:
the web server functionality of said software module communicates live video signals received by the apparatus over a network link connected to the apparatus, said network link comprising one of a LAN network link, a WLAN network link, and an Internet/WAN network llink.

44. An apparatus according to claim 31, further comprising:
VPN processing means, integrated with said router, to provide at least one packet-based VPN tunnel connection over the Internet.

45. An apparatus according to claim 31, further comprising:
a battery backup power source integrally housed within said system housing; and
non-voltatile memory that cooperates with said processing means to automatically store digital video signals received by said apparatus during a predetermined state.

46. An apparatus according to claim 31, further comprising:
a plurality of ports, integrally housed within said system housing, that interface to alarm sensors and other alarm devices, wherein said processing means monitors status signals at said ports to trigger automomatic nofification operation based upon the status signals of said ports.

47. An apparatus according to claim 31, wherein:
said processing means performs automatic configuration operations that upload default configuration settings to said plurality of network cameras through said communication links.

48. An apparatus according to claim 47, wherein:
said automatic configuration operations are carried out by the processing means as part of software module that performs DHCP address assignment.

49. A kit comprising:
the apparatus of claim 32; and
a plurality of wireless IP cameras that communicate to the wireless access point of said apparatus.

50. A kit comprising:
the apparatus of claim 33; and
a plurality of wired IP cameras that communicate to the network switch of said apparatus.

51. A kit comprising:
the apparatus of claim 34;
a plurality of wireless IP cameras that communicate to the wireless access point of said apparatus; and
a plurality of wired IP cameras that communicate to the network switch of said apparatus.

52. A networked security system comprising:
the apparatus of claim 31 and a plurality of network cameras connected to said apparatus, all located at a local site; and
a remote system, located at a remote site, that communicates to the router of the apparatus over the Internet to receive the composite signal generated by the apparatus.

53. A networked security system according to claim 52, wherein:
said remote system includes a DVR recorder that records digital video signals derived from the received composite signal.

54. A networked security system according to claim 53, wherein:
said remote sytem includes a web server that communicates over the Internet digital video signals recorded by the DVR recorder.

55. A networked security system according to claim 54, wherein:
said web server communicates over the Internet video signals derived from the received composite video signal.

56. A networked security system according to claim 51, further comprising:
a remote computer system comprising a browser and plug-in for decoding and viewing of digital video signals communicated over the Internet/WAN by the router of said appliance.

57. A networked security system according to claim 56, wherein:
said remote computer system provides for remote configuration for at least one of the apparatus and said plurality of network cameras.

58. A networked security system according to claim 51, wherein:
the nework interface of said appliance comprises a wireless access point, and said plurality of network cameras comprise wireless IP cameras that connect to the wireless access point of the apparatus.

59. A networked security system according to claim 51, wherein:
the nework interface of said appliance comprises a network switch, and said plurality of network cameras comprise wired IP cameras that connect to the network switch of said apparatus.
